(19) United States
(12) Patent Application Publication
(10) Pub. No.: US 2021/0301368 A1
(43) Pub. Date: Sep. 30, 2021

(54) LASER SHOCK PEENING APPARATUS

(71) Applicant: Airbus SAS, Blagnac (FR)

(72) Inventors: Jeff L Dulaney, Hilliard, OH (US); Timothy T. Gorman, Columbus, OH (US); Mark D. Bloomberg, Columbus, OH (US); Jeffrey A. Jewell, Delware, OH (US); Gary Grossenbacher, Dublin, OH (US); Deitrich O. Kiesewetter, Columbus, OH (US); Gary Walzer, Dublin, OH (US)

(21) Appl. No.: 16/834,896

(22) Filed: Mar. 30, 2020

(51) Int. Cl. C21D 10/00; B23K 26/06; B23K 26/08; B23K 26/146; B23K 26/356

(52) U.S. Cl. CPC C21D 10/005; B23K 26/0648; B23K 26/356; B23K 26/0884; B23K 26/146; B23K 26/0652

(57) ABSTRACT

A laser shock peening device and components thereof. The optical system of the laser peening device includes sapphire optical elements, such as a lens or a prism. A water channel is provided in a pen for the laser shock peening device that has a curved flow path to direct the water. An air conduit in the pen provides a stream of air to the surface receiving the laser shock peening treatment.

### TECHNICAL FIELD

The present invention relates to a laser beam delivery device, and more particularly to such a device used for a laser shock peening application on a workpiece.

### BACKGROUND

In some laser shock peening operations, a laser peens a surface by exciting water molecules which provide a shockwave to the surface. Recently, such an operation has been applied to hidden surfaces, such as bores, apertures, or cavities, of a workpiece. This has resulted in the newer devices for laser peening, such as those disclosed in WO 2019/209786.

The proximity and layout of the hidden surfaces has provided challenges for the use of such a device. For example, many cavities are small, and thus have a limited amount of space. Therefore, providing water, as well as a flow of air, to the surfaces of these cavities can be difficult in these confined spaces. Additionally, it is desirable to provide the shockwave as close to the surface as possible. This requires an economically robust device that is able to accommodate the shockwaves produced.

Accordingly, there is an ongoing need for providing a laser shock peening device, and components thereof, that may be used efficiently and effectively for a laser shock peening application, and in particular for such a device for a laser shock peening application in a bore or cavity of a workpiece.

### SUMMARY

A new laser shock peening device, and components thereof, have been invented. The new laser shock peening device is believed to be robust enough for laser peening surfaces closely positioned thereto. Additionally, the new devices and components are suitably configured for a laser shock peening application in a small, or confined, space.

Accordingly, in at least one aspect, the present invention may be generally characterized as providing a pen for applying a laser shock peening application with a laser on a surface of a workpiece. The pen includes an elongate member having a laser point entry aperture and a laser point exit aperture and at least one sapphire optical element disposed between the laser point entry aperture and the laser point exit aperture.

It is contemplated that a second optical element is disposed between the sapphire optical element and the laser point entry aperture. It is further contemplated that a third optical element is disposed between the second optical element and the sapphire optical element.

In at least one aspect, the sapphire optical element is a prism. The prism may be supported on a reflective platform within the elongate member. The prism may include a first side having a length greater than a length of a second side. The first side may receive the laser from the laser point entry aperture and the second side may provide the laser to the laser point exit aperture.

In at least one aspect, the sapphire optical element comprises a lens. The sapphire lens may have a first side with a first width, and a second side with a second width equal to the first width. It is contemplated that a mirror is positioned between the third optical element and the sapphire optical element.

In various aspects, the at least one sapphire optical element seals the laser point exit aperture.

According to various aspects of the present invention, the present invention may be broadly characterized as providing a pen for applying a laser shock peening application with a laser on a surface of a workpiece in which the pen includes an elongate member having a laser point entry aperture, a laser point exit aperture, and a circularly shaped surface and, a water channel having an inlet and outlet, the water channel defining a water path between the inlet and the outlet. The water path has a portion that is curved along the circularly shaped surface of the elongate member.

In various aspects, the curve has a C-shape. The curve may alternatively have a helical shape. It is contemplated that the elongate member is disposed inside of an outer sleeve. It is further contemplated that the water channel is integrally formed in the circularly shaped surface of the elongate member.

According to some aspects of the present invention, the present invention may further be characterized as generally providing a pen for applying a laser shock peening application with a laser on a surface of a workpiece, and in which the pen has an elongate member comprising a laser point entry aperture and a laser point exit aperture, and an air conduit having an outlet configured to direct a stream of air across the laser point exit aperture and towards the surface of a workpiece.

It is contemplated that the air conduit has a non-circular cross section. It is further contemplated that the air conduit has a cross sectional height that is smaller than a cross sectional length.

These aspects, embodiments, and features, which may be combined in any manner, are described in more detail below and in the attached drawings.

DESCRIPTION OF THE DRAWINGS

One or more exemplary embodiments of the present invention will be described below in conjunction with the following drawing figures, in which:

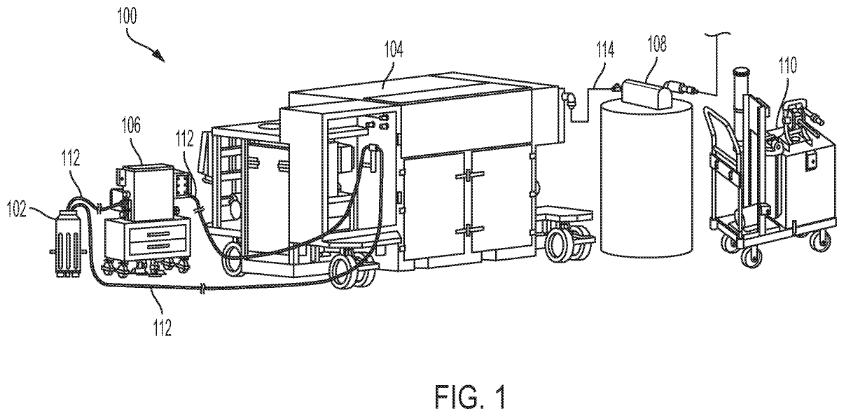

FIG. 1 is a schematic view of a system for performing laser shock peening that is used in accordance with various aspects of the present invention;

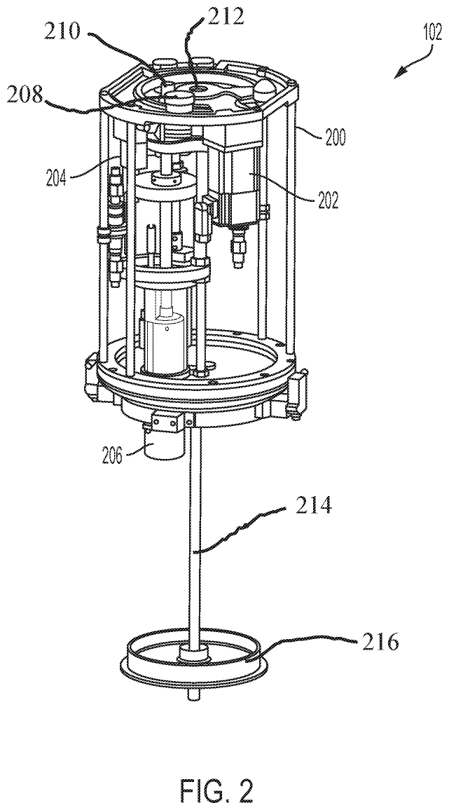

FIG. 2 is a front and top view of a device used in accordance with various aspects of the present invention;

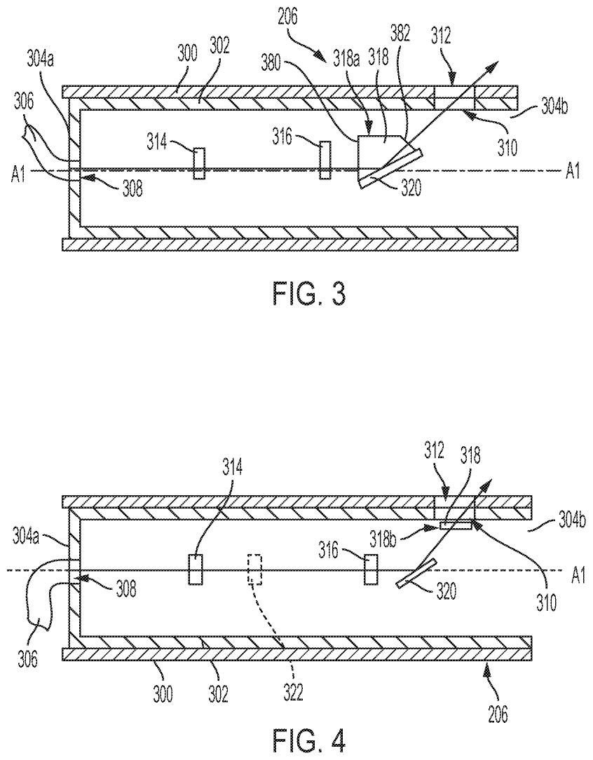

FIG. 3 is a side cutaway view of a pen of a laser shock peening applicator device according to aspects of the present invention;

FIG. 4 is a side cutaway view of another pen of a laser shock peening applicator device according to aspects of the present invention;

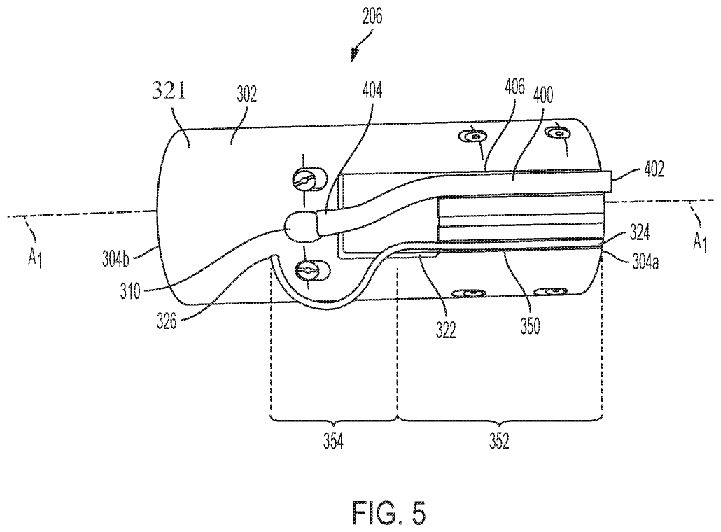

FIG. 5 is a side view of another pen of a laser shock peening applicator device according to aspects of the present invention; and,

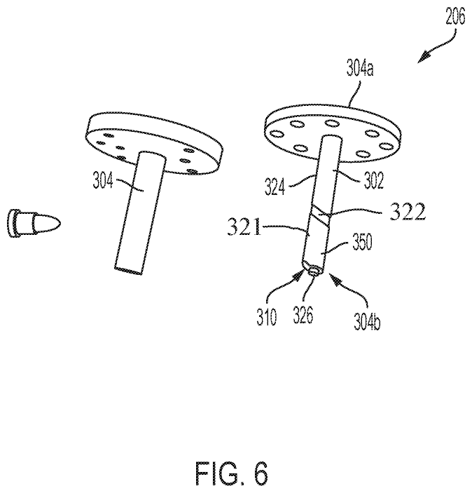

FIG. 6 is a top and front view of a disassembled pen for a laser shock peening applicator device according to aspects of the present invention.

### DETAILED DESCRIPTION

As noted above, the present invention is directed at providing a pen for a laser shock peening applicator device. In various aspects, the optical elements within the pen for focusing and delivering the laser beam include at least one sapphire optical element, which is preferably used to seal the laser exit aperture. The sapphire optical element is sufficiently robust to provide for an efficient and effective laser shock peening treatment. Additionally, to provide the proper water and air flows, various aspects of the water and air supply to the pen are provided to ensure a desired flow of each so that the laser shock peening treatment is consistent throughout the treatment.

With these above general aspects of the present invention in mind, one or more embodiments of the present invention will be described with the understanding that the following description is not intended to limit the present disclosure.

FIG. 1 depicts a system 100 for performing laser shock peening at multiple surface locations on one or more workpieces. This system 100 is particularly suitable for performing laser peening at the inner surfaces of a bore in a workpiece, and in particular for the multiple spar fastener bores in an aircraft wing. However, such a use is not intended to be limiting.

As shown in FIG. 1, the system 100 generally includes an applicator device 102, an enclosure 104, a verification stand 106, a vacuum 108, and a water system 110. The applicator device 102, discussed in more detail below, is the component of the system 100 that interacts with the surface(s) of a workpiece for performing the laser shock peening operation thereon.

The enclosure 104 houses the components that provide the applicator device 102 with a laser beam, power, overly water, and a flow of air. The enclosure 104 further includes a user interface or input device like a touch screen, keyboard, mouse, or the like and a controller for providing the applicator device 102 with control signals for operating motors that insert, advance, retract, and rotate the delivery device in a workpiece bore.

As will be appreciated, a “controller”, as used throughout this application, means a processing unit that includes one or more processors configured to cause a series of steps to be performed so as to implement methods such that instructions, when executed by a computing device or other programmable apparatus, may cause the functions/acts/steps specified in the methods described herein to be executed. The processors may be, for example, any type of general-purpose processor, microprocessor, controller, microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The controller may also include memory that is any suitable known or other machine-readable storage medium. The memory may be a non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the controller such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may include any storage means (e.g., devices) suitable for retrievably storing the computer-executable instructions executable by the processor. Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various configurations, arrangements, or embodiments.

Returning to FIG. 1, the verification stand 106 is operatively interposed between the enclosure 104 and the applicator device 102. This component of the system 100 also includes a controller for evaluating the laser beam at the applicator device 102 to verify characteristics such as spot size, energy, temporal profile, etc. and confirm that the laser being applied by the applicator device 102 meets the desired characteristics to ensure consistent and even laser shock peening application on the surface of the workpiece being treated.

Umbilical cords 112 provide for communication between the enclosure 104 with the applicator device 102 and the verification stand 106, as well as convey power, overlay water, air, and control signals as needed for the enclosure 104 to operate both the applicator device 102 and the verification stand 106. As will be appreciated, each umbilical cord 112 contains one or more conduits, cables, pipes, or other structures.

The vacuum 108 is configured to provides a source of negative pressure to the applicator 102 so that water, dispensed from the applicator 102, can be collected. An air line 114 is extended from the vacuum 108 to the enclosure 104 and the negative pressure is provided to the applicator 102 through the umbilical cord 114.

The water system 110 is included in the system 100 to obtain water obtained from a source, to purify it, and to provide the purified water to the enclosure 104. Thus, the water system 110, which may be a reverse osmosis system, may be separately portable from the enclosure 104. As is known, such a system 110 includes pumps, couplings, filters, and conduits.

Turning to FIG. 2, the applicator device 102 is shown in more detail. The applicator device 102 has multiple components supported on a frame 200. The applicator device 102 includes a motorized rotational drive 202 and a motorized vertical drive 204 for moving a laser peening pen 206. The laser peening pen 206 is disposed at one end of the frame 200 and applies the laser and water to the surface of the workpiece for a laser shock peening treatment. The applicator device 102 also includes various couplings for power 208, water supply, compressed air, and water return 210 and a laser 212, each provided via the umbilical cords 112 (see FIG. 1).

Generally, the applicator device 102 may be secured to a workpiece and the first treatment of the inner surfaces of the bore started. For examples the applicator device 102 may include an elongated shaft 214 and a removable cap 216 that is secured to the elongated shaft 214. For an aperture being treated, the frame 200 is disposed on one side of the aperture and the removable cap is disposed on the opposite side of the aperture.

Turning to FIGS. 3 and 4, the laser peening pen 206 includes an outer sleeve 300 surrounding an inner cylindrical member 302. The inner cylindrical member 302 is an elongate member having a longitudinal axis A1-A1 extending from a first end 304a to a second end 304b. The length of the longitudinal axis A1-A1, from the first end 304a to the second end 304b is much greater than a diameter of the inner cylindrical member 302.

The first end 304a of the inner cylindrical member 302 may be coupled to a fiber optic cable 306 from the umbilical cords 112 (see FIG. 1) which provides the laser. Accordingly, the first end 304a of the inner cylindrical member 302 has a laser point entry aperture 308. Disposed between the second end 304b and the first end 304a of the inner cylindrical member 302 is a laser point exit aperture 310 for the inner cylindrical member 302, and thus the laser peening pen 206. Therefore, a corresponding opening 312 is formed in the outer sleeve 300 so that the outer sleeve 300 may be secured around the inner cylindrical member 302 while allowing the laser to exit the laser peening pen 206 for the laser shock peening treatment.

Disposed between the laser point entry aperture 308 and the laser point exit aperture 310 are one of more optical elements 314, 316, 318, 320, 322. According to various aspects of the present invention, at least one of these optical elements 314, 316, 318, 320, 322 is a sapphire optical element 318. The sapphire element 318, to avoid contamination of plasma, water or other debris back into the inner cylindrical member 302 of the laser peening pen 206, also seals the laser point exit aperture 310. It has been found that the sapphire optical elements 318 are robust enough to reasonably withstand the shock waves created proximate the laser point exit aperture 310.

Accordingly, as shown in FIG. 3, in addition to the sapphire element 318, a contemplated arrangement of optical elements 314, 316, 318, 320, 322 includes a collimating lens 314, a focusing lens 316, and a mirror 320. In FIG. 3, the sapphire element 318 is a sapphire prism 318a. The prism 318a includes an entry side 380, which receives the laser beam (line in FIG. 3), and an exit side 382, from which the laser beam exits the prism 318a. The entry side 380 and the exit side 382 are orientated along intersecting lines and the entry side 380 has a greater length than the exit side 382. The prism entry side 380 is positioned on the mirror 320 so that one side of the prism (neither of the entry or exit sides 380, 382) is adjacent a reflective surface of the mirror 320. This allows the mirror 320 to direct the laser beam at an angle from the longitudinal axis A1-A1 of the inner cylindrical member 302.

In the arrangement shown in FIG. 4, the optical elements 314, 316, 318, 320, 322 again include the collimating lens 314, the focusing lens 316, and the mirror 320. In this arrangement, however, instead of a sapphire prism, the sapphire element 318 is a sapphire lens 318b. The sapphire lens 318b can have any configuration or orientation including having one or more sides that are generally equal in length and which may be convex, concave, or planar. In contrast to the prism 318a which merely bends the light, the sapphire lens 318b also can be used to further focus the laser beam (shown as an arrow in FIG. 4). The mirror 320 is again used to direct the laser beam at an angle from the longitudinal axis A1-A1 of the inner cylindrical member 302.

In both FIGS. 3 and 4, the arrangement of the optical elements 314, 316, 318, 320, 322 is shown along the longitudinal axis A1-A1 of the inner cylindrical member 302. It is also contemplated that the laser path (i.e., the arrows in FIGS. 3 and 4), be displaced away from the longitudinal axis A1-A1 of the inner cylindrical member 302. By using the sapphire optical elements 318, a suitable laser beam can be provided, and the inside of the inner cylindrical member 302 is protected from contamination (water, gas, debris) entering via the laser point exit aperture 310 in an effective and efficient manner

Turning to FIGS. 5 and 6, another aspect of the present invention for the laser peening pen 206 relates to the delivery of water for the laser shock peening application. Specifically, it has been found that obtaining the proper flow properties and direction for the water is important to the laser peening treatment. In addition to being important for consistent laser shock peening application, obtaining the proper water flow may minimize the water which requires less water from the environment and results in less water to cleanup.

Turning to FIGS. 5 and 6, the inner cylindrical member 302 has an outer surface 321 which includes a water channel 322. The water channel 322 extends from an inlet 324, disposed near the first end 304a to couple to a water supply source from the umbilical cords 112 (see FIG. 1), to an outlet 326, disposed at or near the laser point exit aperture 310. Thus, the water channel defines a water path between the inlet 324 and the outlet 326. According to the various embodiments, the water path comprises a curve parallel with the outer circumference of the inner cylindrical member 302.

With respect to FIG. 5, the water channel 322 is formed by a tubular conduit 350 separate from the inner cylindrical member 302. The tubular conduit 350 has a first section 352 that is linear, or parallel with the longitudinal axis A1-A1 of the inner cylindrical member 302. A second section 354 of the tubular conduit 350 is curved along the outer circumference of the inner cylindrical member 302. The second section 354 has a C-shape.

Turning to FIG. 6, the water channel 322 is integrally formed in the outer surface 321 of the inner cylindrical member 302. The pen 206 of FIG. 6 may be used in the application device shown and described in WO/2019/028646. Additionally, in FIG. 6 the water channel 322 has a portion in helical shape.

In either arrangement, by using the curved water channel 322, the desired direction of flow of water across the laser point exit aperture 310 may be achieved.

Returning to FIG. 5, it has also been found important for consistent application that the air flow across the surface that is being treated is properly aligned to effectively and efficiently remove water from the workpiece surface so that the shockwaves of the treatment are striking the surface and not the water or other debris on the workpiece surface. Accordingly, further aspects of the present invention involve the air supply of the pen.

Therefore, in various aspects, the laser peening pen 206 includes an air conduit 400 extending from an inlet 402, disposed near the first end 304a to couple to a air supply source from the umbilical cords 112 (see FIG. 1), to an outlet 404, disposed at or near the laser point exit aperture 310. The outlet 404 of the air conduit 400 is arranged to direct most (at least half) if not all, of the air at the workpiece surface.

The air conduit 400 may be formed as a separate conduit from the inner cylindrical member 302 which is disposed in groove 406 formed in the outer surface 321 of the inner cylindrical member 302. The conduit may have a non-circular cross section, such that a width (distance along the circumference of the inner cylindrical member 302) is greater than a length (distance in a direction along a line running through the longitudinal axis A1-A1 of the inner cylindrical member 302). Such a shape provides an airflow that is spread out over its circumferential length compared with a tubular conduit having a circular cross section.

It should be appreciated that the various aspects of the present invention may be combined in any manner, such as including the optical arrangements of FIGS. 3 and 4, which the application device of FIG. 2, and/or the pens of FIGS. 5 and 6.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A pen for applying a laser shock peening application with a laser on a surface of a workpiece, the pen comprising:
an elongate member comprising a laser point entry aperture and a laser point exit aperture; and,
at least one sapphire optical element disposed between the laser point entry aperture and the laser point exit aperture.

2. The pen of claim 1, further comprising:
a second optical element disposed between the sapphire optical element and the laser point entry aperture.

3. The pen of claim 2, further comprising:
a third optical element disposed between the second optical element and the sapphire optical element.

4. The pen of claim 3, wherein the sapphire optical element comprises a prism.

5. The pen of claim 4, wherein the prism is supported on a reflective platform within the elongate member.

6. The pen of claim 4, wherein the prism comprises a first side having a length greater than a length of a second side, the first side receiving the laser from the laser point entry aperture and the second side providing the laser to the laser point exit aperture.

7. The pen of claim 3, wherein the sapphire optical element comprises a lens.

8. The pen of claim 7, wherein the sapphire lens comprises a first side with a first width, and a second side with a second width equal to the first width.

9. The pen of claim 7, further comprising:
a mirror positioned between the third optical element and the sapphire optical element.

10. The pen of claim 1 wherein the at least one sapphire optical element seals the laser point exit aperture.

11. A pen for applying a laser shock peening application with a laser on a surface of a workpiece, the pen comprising:
an elongate member having a laser point entry aperture, a laser point exit aperture, and having a circularly shaped surface; and,
a water channel having an inlet and outlet, the water channel defining a water path between the inlet and the outlet, wherein the water path comprises a curve along the circularly shaped surface of the elongate member.

12. The pen of claim 11, wherein the curve comprises a C-shape.

13. The pen of claim 11, wherein the curve comprises a helix.

14. The pen of claim 11, wherein the elongate member is disposed inside of an outer sleeve.

15. The pen of claim 11, wherein the water channel is integrally formed in the circularly shaped surface of the elongate member.

16. A pen for applying a laser shock peening application with a laser on a surface of a workpiece, the pen comprising:
an elongate member comprising a laser point entry aperture and a laser point exit aperture; and,
an air conduit having an outlet configured to direct a stream of air across the laser point exit aperture and towards the surface of a workpiece.

17. The pen of claim 16, wherein the air conduit has a non-circular cross section.

18. The pen of claim 16, wherein the air conduit has a cross sectional height that is smaller than a cross sectional length.
